(19) United States
(12) Patent Application Publication
(10) Pub. No.: US 2011/0132474 A1
(43) Pub. Date: Jun. 9, 2011

(54) Back Flow Prevention System

(75) Inventors: James T. Reese, Logan, UT (US); Ronald White, Hyde Park, UT (US)

(73) Assignee: Utah State University, North Logan, UT (US)

(21) Appl. No.: 12/962,813

(22) Filed: Dec. 8, 2010

Related U.S. Application Data
(60) Provisional application No. 61/285,123, filed on Dec. 9, 2009.

(51) Int. Cl. F16K 31/12; F16K 37/00

(52) U.S. Cl. 137/487.5; 137/551

(57) ABSTRACT

A system that prevents the backflow of fluid is disclosed. The system comprises a housing, two rubber flaps that are attached in such a way to create a one-way valve, and a water sensor. The flaps are anchored to the inside of the housing and open due to the force of fluid flowing in one direction. Fluid flowing in the opposite direction presses the ends of the flaps against each other, thus closing the valve and preventing water from backflowing through the system. A water sensor, mounted within the housing, is activated when a backflow fills the housing, thus providing an alarm to indicate a backflow event has occurred.

### FIELD OF THE INVENTION

This invention relates to a backflow prevention system and in particular to a one-way valve that utilizes flexible rubber flaps to prevent fluid flow in an undesired direction.

### BACKGROUND OF THE INVENTION

Sewer systems containing pipes provide a way to remove dirty water and waste from residential dwellings and businesses. During rain storms and other times of high liquid volumes or when obstructions are introduced, the sewer systems can become backed up, and the waste water flows back through the pipes into homes and businesses causing serious and costly damage. Each year in the United States sewers back up in basements several hundred thousand times from the more than 50,000 municipal sanitary systems that overflow. Harmful pathogens are released and conditions are created where black mold can grow. Often the backflow problems arise when raw sewage and storm drainage use the same pipeline. During heavy rainfall, system may become overloaded causing waste water to flow back into homes and businesses. An aging pipeline system in the United States increases the chance of a poor removal of waste water and an increase in flooding. Solids and other items put into the drains may also stop the flow and cause a backup.

The current technologies that address these backflow issues have inherent deficiencies that reduce their effectiveness. These deficiencies are associated with systems that are a) not leak-proof, b) difficult to install, c) costly, d) difficult to clean, e) not strong enough to withstand heavy pressure, and f) do not communicate the occurrence of a clogged pipe or backflow situation.

Inventions that attempt to address backflow issues include duckbill type valve designs that use a shaped rubber member that closes on itself. It is anticipated this valve would be difficult to clean, and because the bottom of the valve is not mounted to the pipe a cleaning snake would snag on the valve and possibly damage it. Without attaching the bottom lip to the pipe, it is possible that the valve would turn inside out under high pressure. In one example, the valve closes because of difference in thickness of the lips in the valve. This type of valve has lips which fold to close. The folded rubber may result in a seal that is not completely leak proof at all pressures.

There is a need for a low cost backflow valve that is easy to install, easy to clean, has a leak-proof seal, requires no power, and can be installed either inside or outside of a building. The public would benefit from a reliable system that protects their homes and businesses from backflow containing harmful liquids, gases and destructive material.

### SUMMARY OF THE INVENTION

The disclosed invention is a backflow prevention system consisting of a valve housing, a rubber one-way valve, and an alarm. Applications for the device include, but are not limited to, sewer systems, storm drains, pipelines, and liquid transfer systems. When sewer and other fluid systems experience heavy flow or obstructions, the fluid can be backed up, creating strong reverse pressure to residential and business plumbing systems, resulting in flooding buildings.

The system comprises two rubber flaps attached in such a way that fluid is allowed to flow through a channel between the two flaps in only one direction. The pressure of the fluid on the flaps during a backflow causes the channel to seal itself against the fluid flow. The system also employs a warning alarm to alert the user of a backflow problem. The two flaps, which lie in the valve housing, are attached to each other on the sides. The flaps may be two individual pieces of rubber or may be a single piece of rubber. The flaps are attached to an inlet pipe coming from the building in a way to keep the flaps in an open position to allow water to flow through the valve. The open position allows fluid to flow through the valve if the fluid is flowing away from the building. The edges of the flaps that run parallel with the pipes are attached to each other. At least one anchor is used to attach the flaps to the valve housing or another internal structural component in the corners of the flaps at the exit of the valve. The two flaps lie on the bottom of the valve housing, with one flap on top of the other, both flaps following the curvature of the valve housing. The flaps lie on top of one another in such a way to make a seal when fluid flows back toward the outlet pipe of the building instead of flowing away from it. The bottom flap may be attached to the bottom of the inside of the valve housing so as to prevent the bottom flap from moving and preventing the valve from folding in on itself. The sides of the flaps are sealed together to prevent the flow of fluid in or out of the channel on the sides. An alarm sensor is mounted within the valve housing but outside the one-way rubber valve. When fluid begins to flow back toward the one-way valve and inlet pipe, the fluid accumulates outside the channel, because it cannot flow back through the valve. As the fluid level rises in the valve housing, it is detected by the sensor which communicates with an alarm to notify the user of a backflow issue. This provides an early warning notification of a backflow problem. This one-way valve creates a leak-proof seal. The valve is easily cleaned and no power is needed. It provides a reliable, low-cost solution to an increasing problem. When cleaning is needed the valve can be cleaned without folding inside out. It also provides an early warning notification for users.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a schematic of one embodiment showing the flap configuration inside the valve housing.

FIG. 2 is an end view of the one-way valve in the closed position with the flaps together.

FIG. 3 is a schematic illustrating another embodiment showing the flap configuration inside the valve housing.

FIG. 4 is a schematic illustrating another embodiment of the configuration inside the valve housing.

FIG. 5 is an end view of another embodiment of the one-way valve in the closed position. The view is inside the valve housing from the viewpoint of the outlet pipe.

FIG. 6 is an illustration of a potential backflow situation showing the relationship between the building pipe system and the sewer system.

FIG. 7 is an end view of the one-way valve in the open position.

### DETAILED DESCRIPTION OF SELECTED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

Backflow of waste water has caused serious damage for home and business owners when their basements flood. There is a need for a simple to install, low-cost, reliable, and easily cleaned one way valve that prevents the backflow of fluid waste. The disclosed rubber one-way valve utilizes a reliable and easy to install apparatus that provides a simple solution to an increasing problem. While the actual valve does not require electrical power, the sensor does need a power source.

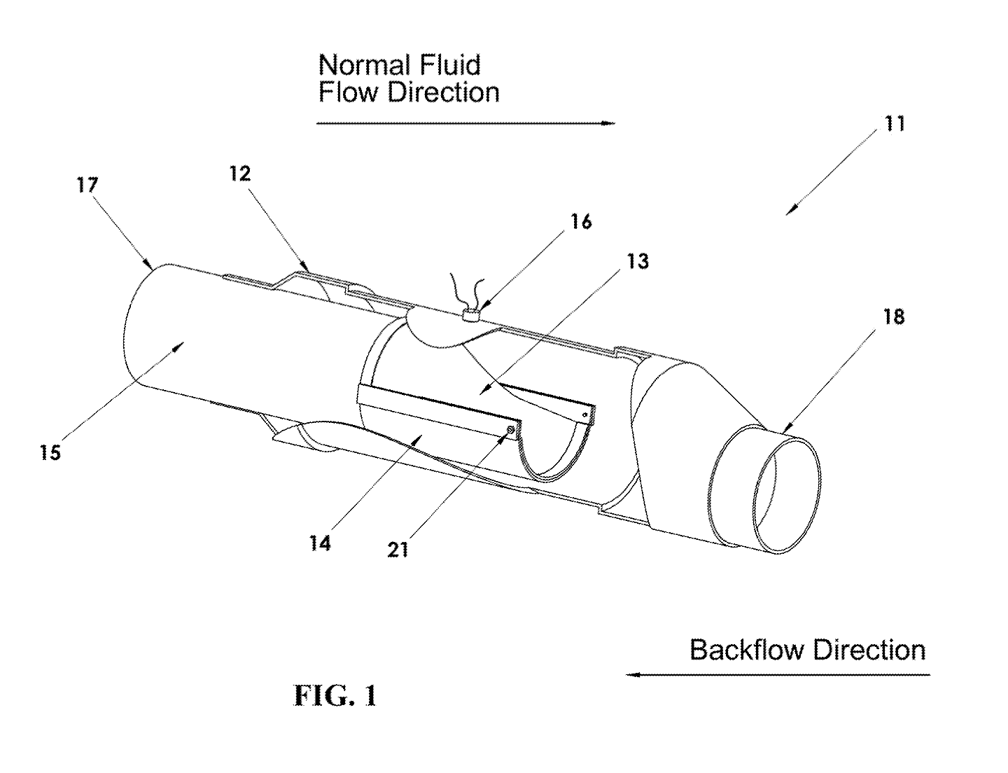

The backflow prevention system 11 shown in a cut away view in FIG. 1 consists of a valve housing 12, a top flap 13 and a bottom flap 14 which form a one-way valve, a pipe section 15, and a water sensor 16. The diameter of the housing 12 in its central region is larger than the diameter of the inlet pipe 17 and the outlet pipe 18. The valve housing 12 may be a plastic or PVC pipe, a molded material, or any other cylindrical material of appropriate strength. Additionally, the housing may be a square tube or it may have a different geometric cross section shape. The valve housing 12 is inserted into a plumbing system by connecting it to the outlet pipe 18 by means of pipe reducers, couplers, and the like. Within the housing 12 on the upstream end of the backflow prevention system 11 is the cylindrical pipe section 15 with a diameter smaller than the diameter of the central region of the housing 12. This cylindrical pipe section 15 protrudes a distance into the housing 12. The pipe section 15 is attached to the inlet pipe 17. Additionally, the housing 12 may be manufactured with tapered ends and an integrated pipe section 15 such that the diameter of each end is equal to the diameter of the inlet pipe 17 and outlet pipe 18 whereby the connections are made by standard plumbing techniques.

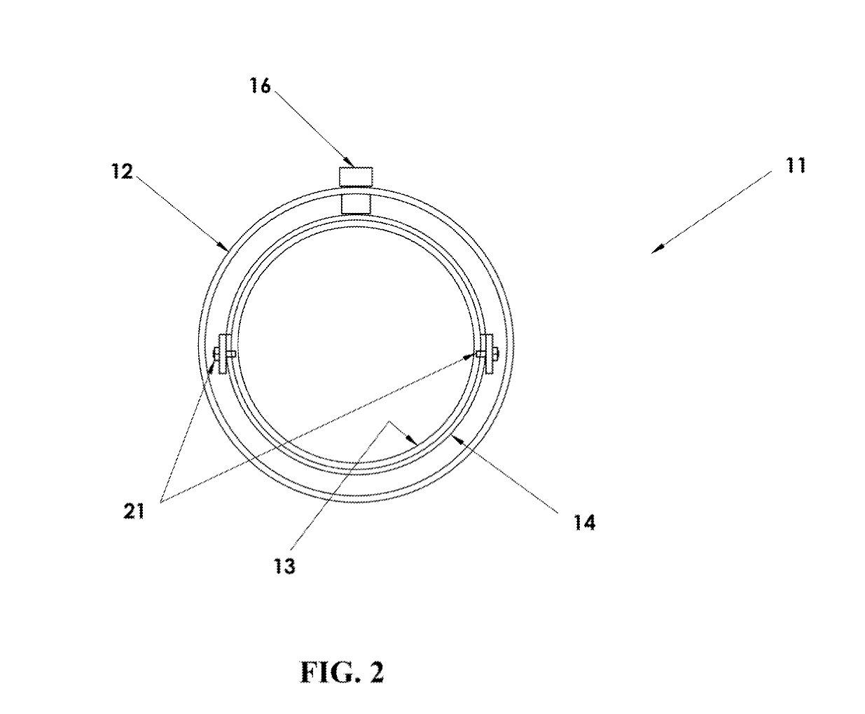

Within the valve housing 12 is a one-way rubber valve that consists of a top flap 13 and a bottom flap 14 which are shown in FIGS. 1, and 2. The edges of the flaps 13, 14 are fastened together to form a sleeve type structure. The bottom rubber flap 14 lies inside the valve housing 12 on the bottom surface so as to conform to the shape of the valve housing 12 as shown in the cut away end view in FIG. 2. The downstream end of the top flap 13 rests on the downstream end of the bottom flap 14 and also conforms to the shape of the valve housing 12. The top flap 13 and bottom flap 14 may be the same length or they may be different lengths. The flaps 13, 14 may be two individual pieces of rubber or may be a single piece of rubber dimensioned and cut appropriately. In one embodiment the top flap 13 is shorter in length than the bottom flap 14. The downstream end of the top flap 13 is in contact with, and rests on, the downstream end of the bottom flap 14 in the region where fluid exits the valve thus creating a seal when fluid is not flowing through the backflow prevention system 11 or when fluid is moving in the reverse direction.

The upstream ends of the flaps 13, 14 are sealed to the downstream circumference of the pipe section 15. Referring to FIGS. 1 and 2, the upstream end of the bottom flap 14 is fastened to the bottom half of the circumference of the cylindrical pipe section 15 that protrudes into the housing 12. The upstream end of the top flap 13 is fastened to the top half of the circumference of the cylindrical pipe section 15 that protrudes into the housing 12. The sizes of the top flap 13 and the bottom flap 14 may be varied so that one covers more than half of the circumference of the cylindrical pipe section 15 and the other covers less than half of the circumference of the cylindrical pipe section 15. The upstream ends of the top flap 13 and a bottom flap 14 when fastened to the cylindrical pipe section 15 must together completely cover the circumference or perimeter of the cylindrical pipe section 15. The top flap 13 and a bottom flap 14 may be fastened to the end of the cylindrical pipe section 15 by a clamp, adhesive, or any, other mechanism know to one skilled in the art. The top flap 13 and the bottom flap 14 are attached to each other along their edges that are oriented parallel to the length of the valve housing 12. The edges of the flaps 13, 14 may be sealed together by techniques known in the art to form a sleeve.

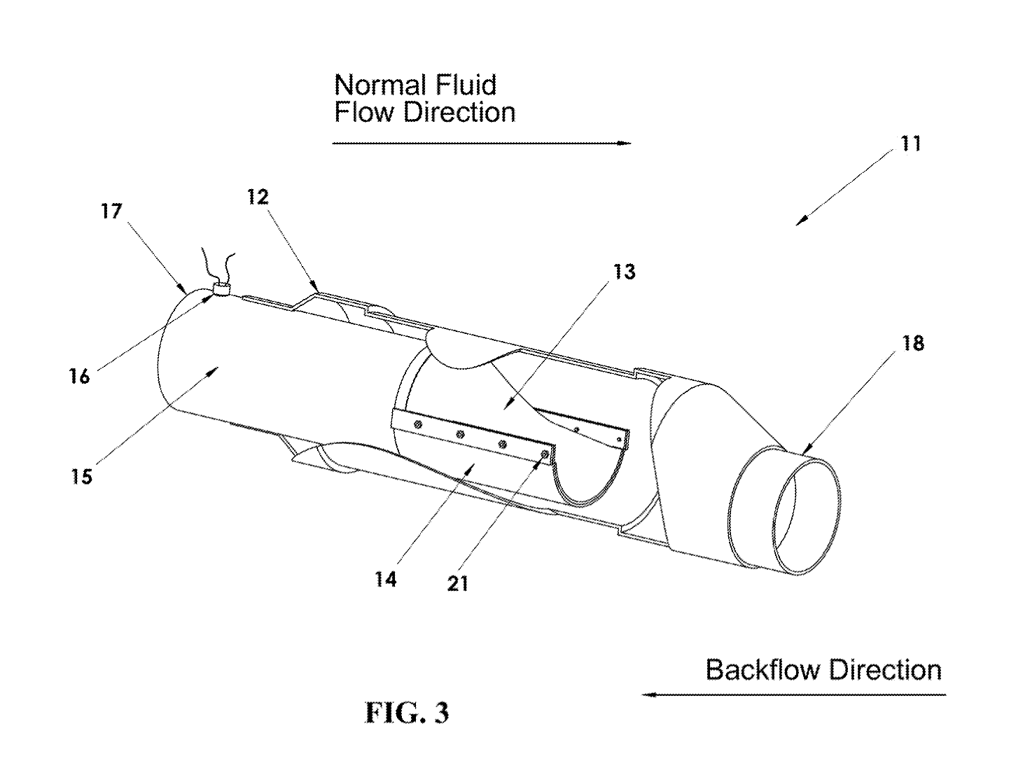

The bottom flap 14 may be attached to the inside bottom surface of the valve housing 12 using a variety of fastening means including but not limited to adhesives, anchors, rivets, screws, bolts, and the like. This is one technique to maintain the basic shape of the flaps under backflow conditions. The top flap 13 is stacked or positioned over the bottom flap 14 as shown in FIG. 2. This relationship between the flaps 13, 14 produces a zero leak system during a backflow event. The top flap 13 and bottom flap 14 may be attached to each other and the valve housing 12 using anchors 21 which may be any type of appropriate fastener or adhesive. These anchors 21 are located at the downstream corners of the top flap 13 and bottom flap 14 where fluid exits the valve. The flaps 13, 14 may be anchored in only the corners as shown in FIGS. 1 and 2, or they may be anchored to each other and the valve housing at multiple points along the edges of the flaps that run parallel to the valve housing as shown in FIG. 3.

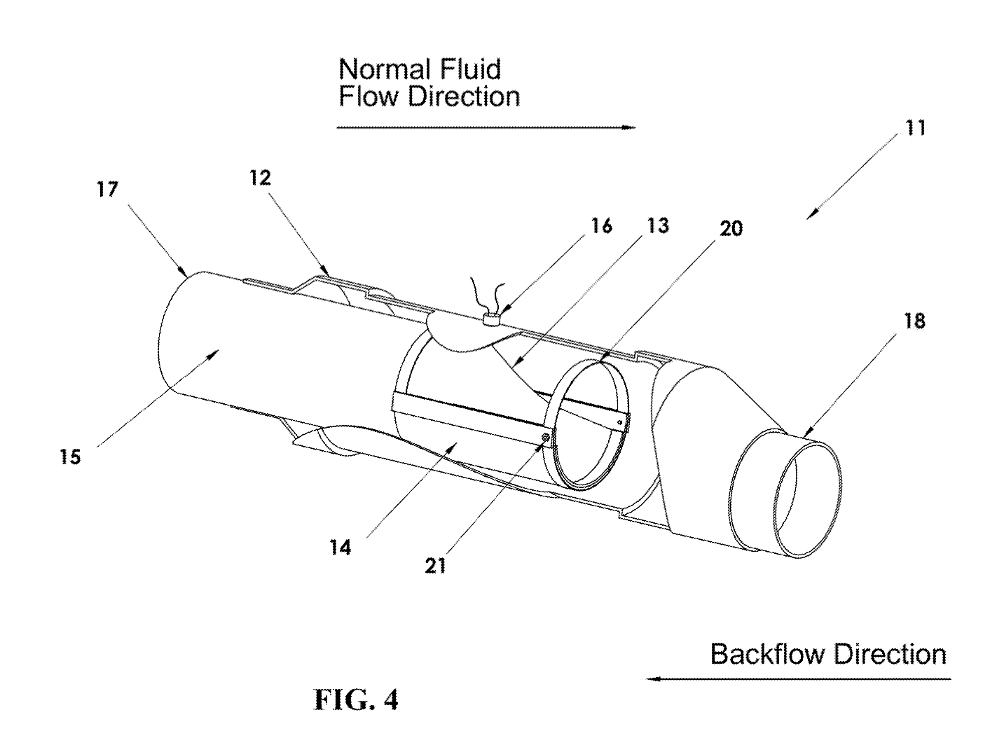

In another embodiment, shown in FIG. 4, the top flap 13 and bottom flap 14 are attached to each along their edges and the downstream corners are attached to a circular rigid band 20 within the housing 12. The rigid band 20 provides internal structure to the valve. In this embodiment the bottom flap 14 may or may not be attached to the inside bottom surface of the valve housing 12. The upstream ends of the flaps 13, 14 are fastened to the cylindrical pipe section 15 as previously described.

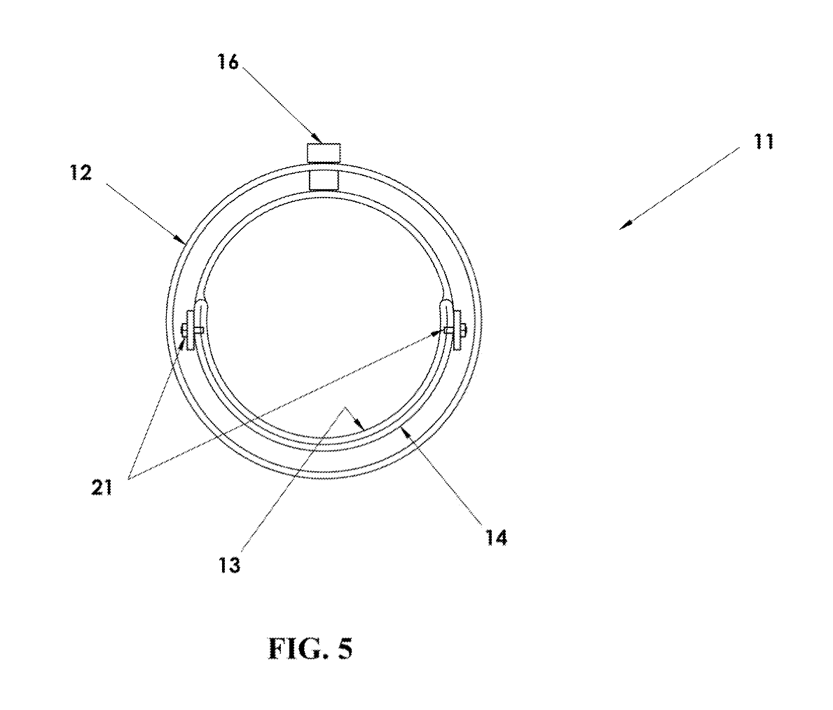

FIG. 5 illustrates an embodiment in which the flaps 13, 14 are constructed from a single piece of material, such as a flexible rubber sleeve. The sleeve is folded over at the fastening points such that the top flap 13 is flush in contact with the bottom flap 14 as shown in FIG. 5. This relationship between the flaps 13, 14 produces a zero leak system during a backflow event.

A water sensor 16 is positioned within the backflow prevention system 11 to provide notification when a backflow is present. The water sensor 16 may be located within the housing 12 at a position above the normal water flow as shown in FIG. 1. The water sensor 16 may be any type of sensor that is triggered when immersed in water. In another embodiment, the water sensor 16 is located in the cylindrical pipe section 15 upstream from the flaps 13, 14 as shown in FIG. 3. The water sensor 16 may be configured to initiate an audio alarm when a backflow is detected. The sensor may also be configured to remotely send a message to a pager, telephone, automated messaging device or the like to provide notification of a backflow event.

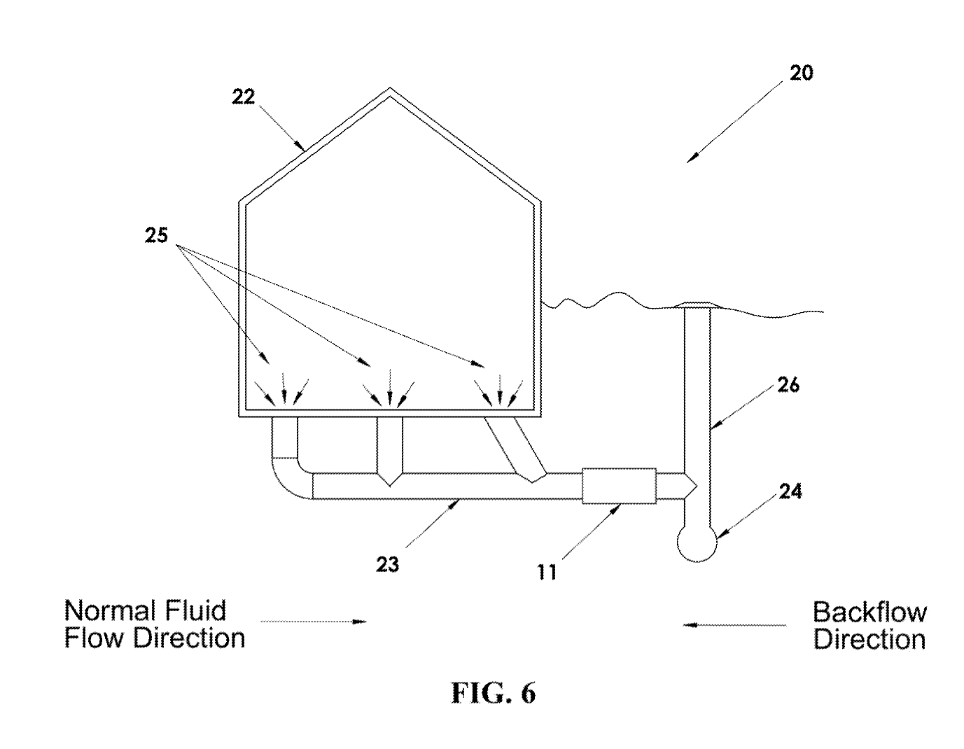

A backflow event generally occurs when there is a large amount of waste fluid in the public sewer system or the public sewer system is plugged thus reducing the amount of water the system can accommodate and inhibiting the flow of water into the sewer system. FIG. 6 is a schematic showing a potential backflow scenario 20. The building 22 has a pipe system 23, which transports waste fluid 25 away from the building. If there is an excess amount of waste fluid or a plugged line in the public sewer pipeline 24 the fluid can flow back towards the building 22, in the backflow direction. If a backflow prevention system 11 were absent, waste water and backflow fluids 25 would flow in an unwanted direction and be discharged in the building 22. The likelihood of a backflow increases when the public sewer pipe 24 is used by the storm drain system 26. During heavy rainfall the chance of a backflow is increased. The backflow prevention system 11 may be installed in the pipe system 23 that transports waste fluid away from the building 22 in a location between the building and the public sewer pipe 24. The backflow prevention system 11 prevents the backflow of waste fluid 25 into the building 22, and provides an early warning notification to the occupants of the building.

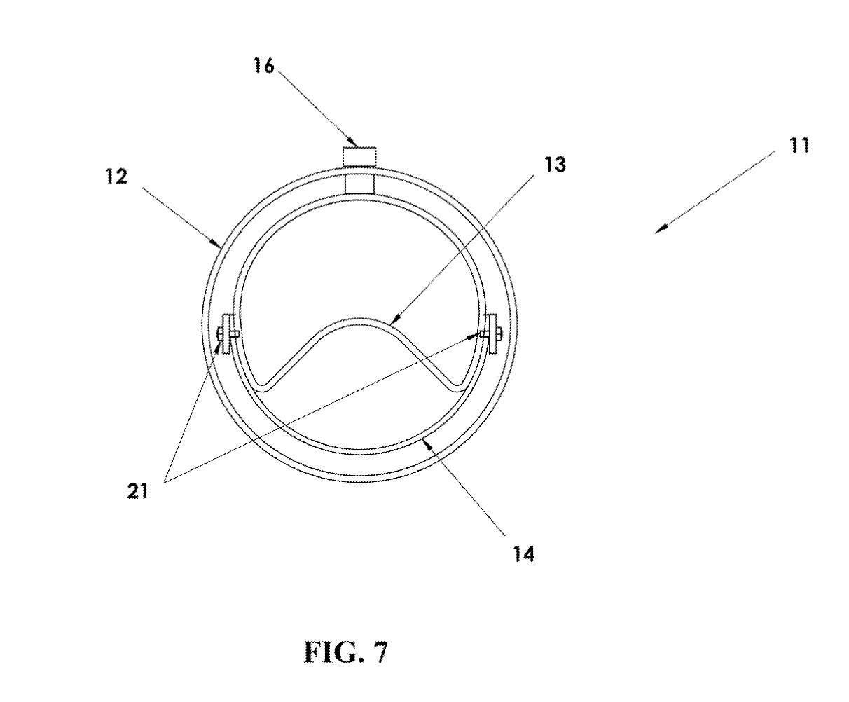

Under normal operating conditions, i.e. in the absence of backflow, liquid being discharged from the building 22 flows through the backflow prevention system 11 from the inlet pipe 17 through the cylindrical pipe section 15, and passes between the top flap 13 and the bottom flap 14 within the housing 12. The flow pressure is sufficient to cause the downstream end of the top flap 13 to rise from the bottom flap 14, as shown in FIG. 7, thus opening the valve and allowing water to pass and exit through the outlet pipe 18. When the flow subsides, gravity causes the downstream end of the top flap 13 to move down and rest on the downstream end of the bottom flap 14, thus closing the valve.

When a backflow event occurs, water moves in the reverse direction and enters the backflow prevention system 11 through the outlet pipe 18. Because the top flap 13 and the bottom flap 14 are in contact, as shown in FIGS. 1 and 2, the backflow waste fluid passes over the top flap 13 and into the housing 12. The backflow pressure pushes the end of the top flap 13 down against the bottom flap 14, thus keeping the valve closed and preventing water from flowing back through the pipe system 23 into the building 22. Anchoring the flaps of the one-way valve, as previously described, prevents the rubber flaps 13, 14 from inverting due to the backflow pressure. The anchors also keep the flaps 13, 14 in place allowing the one-way valve to be easily cleaned without damaging the rubber flaps 13, 14 or inverting them inside out.

During a backflow event the waste fluid 25 accumulates in the valve housing 12. The rise of the fluid level in the valve housing 12 is detected by one or more water sensors 16 positioned inside the housing 12. The sensor sends a signal to an alarm device that communicates the occurrence of a backflow event. Since the valve housing 12 incorporates a wider area than the inlet pipe 17 and outlet pipe 18, there is additional space for the accumulation of waste fluid before the sensor 16 is activated, thus insuring that the normal flow of liquid through the backflow prevention system 11 does not trigger false alarms.

In another embodiment the water sensor 16 may be located at the top of the cylindrical pipe section 15 upstream from the rubber flaps 13, 14 as shown in FIG. 3. The water sensor 16 may be located either within the housing 12 or upstream outside the housing 12 depending on the configuration of the system 11. During a backflow event, the backflow pressure pushes the end of the top flap 13 down against the bottom flap 14, thus keeping the valve closed and preventing water from flowing back through the pipe system 23 into the building 22. With the backflow prevention system 11 closed due to a backflow event, water is also restricted from flowing into the valve from the building 22. In this configuration, the alarm 16 is triggered by additional water flowing into the system from the building 22. The water is stopped upstream from the closed flaps 13, 14, thus additional flow fills the pipe section 15 and triggers the sensor 16. The alarm warns occupants that continued flow of water into the pipe system 23 of the building 22 will result in waste fluids 25 being released within the building.

While specific embodiments of the backflow prevention system have been illustrated and described, it is to be understood that the disclosed invention is not limited to the precise configuration, components, and methods disclosed herein. Various modifications, changes, and variations apparent to those of skill in the art may be made in the arrangement, operation, and details of the device and method of the present invention disclosed herein without departing from the spirit, scope, and underlying principles of the disclosure. The described embodiments are to be considered in all respects as illustrative and not restrictive. Therefore, the scope of the invention is indicated by the appended claims, rather than by the foregoing description.

1. An apparatus for preventing backflow through plumbing systems comprising:
a housing with a first open end and a second open end;
a pipe section, sealed in said first open end of said housing with a first end extending away from said housing and a second end protruding into said housing;
a flexible top flap with a first end, a second end, a left edge, and a right edge;
wherein said first end of said top flap is sealed to the top portion of said second end of said pipe section;
a flexible bottom flap with a first end, a second end, a left edge, and a right edge;
wherein said first end of said bottom flap is sealed to the bottom portion of said second end of said pipe section;
wherein said first end of said top flap and said first end of said bottom flap cover the perimeter of said second end of said pipe section;
wherein said left edge of said top flap is sealed to said left edge of said bottom flap;
wherein said right edge of said top flap is sealed to said right edge of said bottom flap; and
a water sensor within said housing.

2. The apparatus of claim 1 wherein:
a first anchor fastens the corner of said top flap defined by its said second end and said left edge and the corner of said bottom flap defined by its said second end and said left edge to said housing; and
a second anchor fastens the corner of said top flap defined by its said second end and said right edge and the corner of said bottom flap defined by its said second end and said right edge to said housing.

3. The apparatus of claim 1 wherein:
a rigid band is positioned around the internal circumference of said housing;
a first anchor fastens the corner of said top flap defined by its said second end and said left edge and the corner of said bottom flap defined by its said second end and said left edge to said rigid band; and
a second anchor fastens the corner of said top flap defined by its said second end and said right edge and the corner of said bottom flap defined by its said second end and said right edge to said rigid band.

4. The apparatus of claim 1 wherein said bottom flap is attached to the inside bottom surface of said housing.

5. The apparatus of claim 1 wherein said water sensor is positioned within said housing on the top inside surface.

6. The apparatus of claim 1 wherein the central section of said valve housing has a larger cross sectional area than its said first open end and said second open end.

7. The apparatus of claim 1 wherein said top flap is shorter than said bottom flap.

8. The apparatus of claim 1 wherein said top flap and said bottom flap are high strength rubber.

9. The apparatus of claim 8 wherein said top flap and said bottom flap are a single piece of rubber.

10. The apparatus of claim 1 wherein when no fluid is in the apparatus said second end of said top flap lies on said second end of said bottom flap.

11. The apparatus of claim 1 wherein when fluid enters said housing from said first there is sufficient force to cause said second end of said top flap to rise from said second end of said bottom flap to allow said fluid to flow through said housing.

12. The apparatus of claim 1 wherein when fluid enters said housing from said second end, said fluid flows over said top flap forcing said second end of said top flap down onto said second end of said bottom flap thus blocking fluid flow from exiting said housing through said first end.

13. The apparatus of claim 12 wherein when fluid fills said housing and contacts said sensor an alarm is triggered to signal a backflow event.

14. A one way valve comprising:
the edges of a top flap fastened to the edges of a bottom flap forming a sleeve;
one end of said sleeve fastened to the circumference of a pipe section;
said pipe section fastened to the end of a housing wherein;
the end of said pipe section with said sleeve is protruding within said housing;
said sleeve extends from the end of said pipe section further into said housing;
the end of said pipe section without said sleeve is extending away from said housing; and
a water sensor within said housing.

15. The apparatus of claim 14 wherein there is a first anchor and a second anchor in the end of said sleeve away from said pipe section;
said first anchor fastens an edge of said sleeve to the internal side wall of said housing; and
said second anchor fastens the opposite edge of said sleeve to the opposite internal side wall of said housing.

16. The apparatus of claim 14 wherein a rigid band is positioned around the internal circumference of said housing and anchors fasten an edge of said sleeve to each side of said rigid band.

17. The apparatus of claim 14 wherein said bottom flap is attached to the inside bottom surface of said housing.

18. The apparatus of claim 14 wherein said water sensor is positioned within said housing on the top inside surface.

19. The apparatus of claim 14 wherein the ends of said valve housing have a smaller cross sectional area than its center.

20. The apparatus of claim 14 wherein said top flap is shorter than said bottom flap.

21. The apparatus of claim 14 wherein said top flap and said bottom flap are high strength rubber.

22. The apparatus of claim 21 wherein said top flap and said bottom flap are a single piece of rubber.

23. The apparatus of claim 14 wherein when no fluid is in the apparatus the end of said sleeve away from said pipe section is closed.

24. The apparatus of claim 14 wherein when fluid enters said housing through said pipe section there is sufficient force to cause said sleeve to open and allow said fluid to flow through said housing.

25. The apparatus of claim 14 wherein when fluid enters said housing from the end opposite said pipe section, said fluid flows over said sleeve thus blocking fluid flow from exiting said housing through said pipe section.

26. The apparatus of claim 25 wherein when fluid fills said housing and contacts said sensor an alarm is triggered to signal a backflow event.

27. An apparatus for preventing backflow through plumbing systems comprising:
a housing with a first open end and a second open end;
a pipe section, sealed in said first open end of said housing with a first end extending away from said housing and a second end protruding into said housing;
a flexible top flap with a first end, a second end, a left edge, and a right edge;
wherein said first end of said top flap is sealed to the top portion of said second end of said pipe section;
a flexible bottom flap with a first end, a second end, a left edge, and a right edge;
wherein said first end of said bottom flap is sealed to the bottom portion of said second end of said pipe section;
wherein said first end of said top flap and said first end of said bottom flap cover the perimeter of said second end of said pipe section;
wherein said left edge of said top flap is sealed to said left edge of said bottom flap;
wherein said right edge of said top flap is sealed to said right edge of said bottom flap; and
a water sensor positioned within said pipe section on the top inside surface.

28. A one way valve comprising:
the edges of a top flap fastened to the edges of a bottom flap forming a sleeve;
one end of said sleeve fastened to the circumference of a pipe section;
said pipe section fastened to the end of a housing wherein;
the end of said pipe section with said sleeve is protruding within said housing;
said sleeve extends from the end of said pipe section further into said housing;
the end of said pipe section without said sleeve is extending away from said housing; and
a water sensor positioned within said pipe section on the top inside surface.
